(19) United States
(12) Patent Application Publication
(10) Pub. No.: US 2007/0162593 A1
(43) Pub. Date: Jul. 12, 2007

(54) Abstracting help calls using a documentation abstraction layer

(75) Inventor: James Robert Morey, North Bend, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/327,914

(22) Filed: Jan. 9, 2006

(51) Int. Cl. G06F 15/173

(52) U.S. Cl. 709/224

(57) ABSTRACT

A documentation abstraction layer facilitates the abstraction of help calls. When help is instigated in a client program, the client program may send a dialog ID to a documentation abstraction layer. The documentation abstraction layer maps the dialog ID to calls for obtaining help dialogs. The documentation abstraction layer generates a help call to a help service and the help service sends a help dialog to the client program. In this manner, the documentation abstraction layer facilitates updating help services without modification of the client program.

### BACKGROUND

During the navigation of a client program, a user may require help with the client program. Many programs provide a help service where a user may select a help button to receive a help dialog. In doing so, the client program makes a call directly to the help service to request the help dialog. When the help dialog requires updating, the client program must also be updated to include a new call.

### SUMMARY

This Summary is provided to introduce a selection of concepts in a simplified form that are further described below in the Detailed Description. This Summary is not intended to identify key and/or essential features of the claimed subject matter. Also, this Summary is not intended to limit the scope of the claimed subject matter.

A documentation abstraction layer facilitates the abstraction of help calls. When help is instigated in a client program, the client program may send a dialog ID to a documentation abstraction layer. The documentation abstraction layer maps the dialog ID to calls for obtaining help dialogs. The documentation abstraction layer generates a help call to call a help service and the help service sends a help dialog to the client program. In this manner, the documentation abstraction layer facilitates updating help services without requiring that the client program is updated.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 illustrates an exemplary computing device;

FIG. 2 represents one exemplary system overview for abstracting help calls;

FIG. 3 represents one exemplary time dependent flow diagram for abstracting help calls; and

FIG. 4 is an operational flow diagram representing an exemplary embodiment for abstracting help calls.

### DETAILED DESCRIPTION

Embodiments are described more fully below with reference to the accompanying drawings, which form a part hereof, and which show specific exemplary embodiments. However, embodiments may be implemented in many different forms and should not be construed as limited to the embodiments set forth herein; rather, these embodiments are provided so that this disclosure will be thorough and complete, and will fully convey the scope. Embodiments may be practiced as methods, systems or devices. Accordingly, embodiments may take the form of an entirely hardware implementation, an entirely software implementation or an implementation combining software and hardware aspects. The following detailed description is, therefore, not to be taken in a limiting sense.

The logical operations of the various embodiments are implemented (1) as a sequence of computer implemented steps running on a computing system and/or (2) as interconnected machine modules within the computing system. The implementation is a matter of choice dependent on the performance requirements of the computing system implementing the invention. Accordingly, the logical operations making up the embodiments of the present invention described herein are referred to alternatively as operations, steps or modules.

### Illustrative Embodiments for Abstracting Help Calls Using a Documentation Abstraction Layer

A documentation abstraction layer facilitates the abstraction of help calls. The documentation abstraction layer is a program apart from a client program that requests help. When help is required in a client program, a user may instigate a request in a program. For example, a user may “click” a help button. The program transmits a dialog ID to the documentation abstraction layer to indicate where in the program help is required. The documentation abstraction layer maps the dialog ID to one or more references for calling a help service. The documentation abstraction layer generates a help call to a help service and the help service transmits a help dialog to the client program.

In this manner, the documentation abstraction layer facilitates updates for a help service without requiring that the client program be updated. Succinctly stated, aspects of the disclosure provide an efficient, cost effective and time efficient manner for updating a help service. Also, the documentation abstraction layer facilitates associating more than one help service with the program. Since, in one example of the disclosure, the documentation abstraction layer and the client program are separate programs, the documentation abstraction layer is updated in order to update help service calls. Such elements of the disclosure facilitate updating help service calls without requiring a new version of the client program or updates to the client program. The documentation abstraction layer facilitates remapping help topics, adding help topics, removing help topics, changing help topics located on a client, and/or mapping to new online URLs.

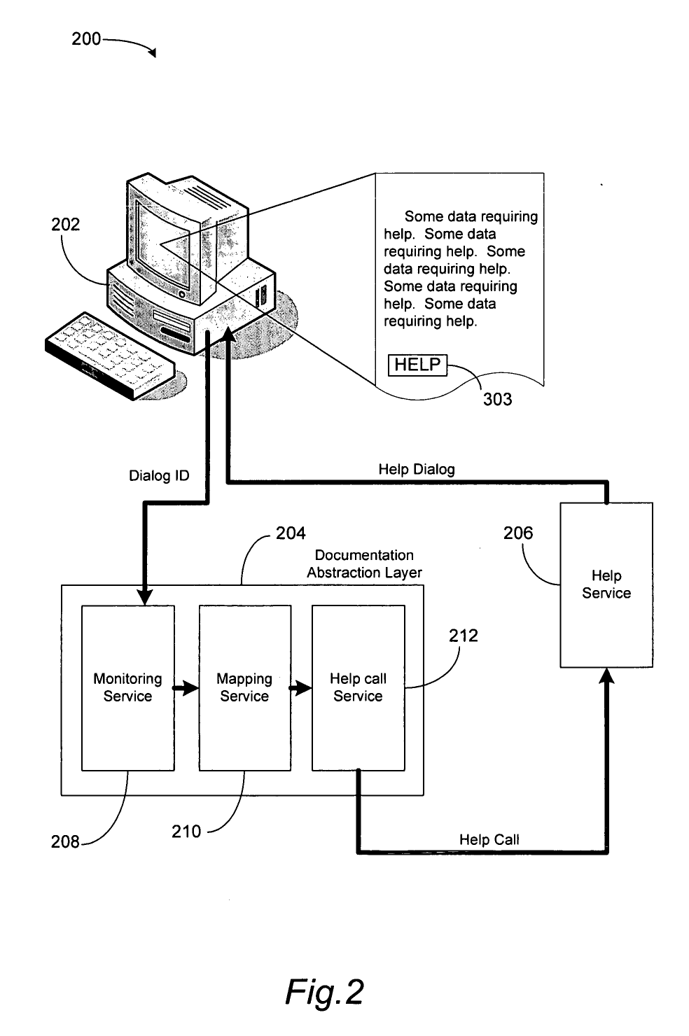

FIG. 2 represents one exemplary system overview 200 for abstracting help calls using a documentation abstraction layer. System 200 represents a modular overview. System 200 may be integrated as a combination of software and hardware elements, an operating system or any combination thereof. Hardware, databases, software, applications, and or programs referenced herein may be integrated as a single element or include various elements in communication with one another. Software and/or hardware elements are depicted herein for explanatory purposes only and not for limiting the configuration to multiple elements or a single element performing several functions unless specifically specified herein. For example as depicted in FIG. 2, system 200 includes client 202 having client programs associated therewith. System 200 also includes documentation abstraction layer 204 and help service 206. In one aspect, documentation abstraction layer 204 includes monitoring service 208, mapping service 210, and help call service 212.

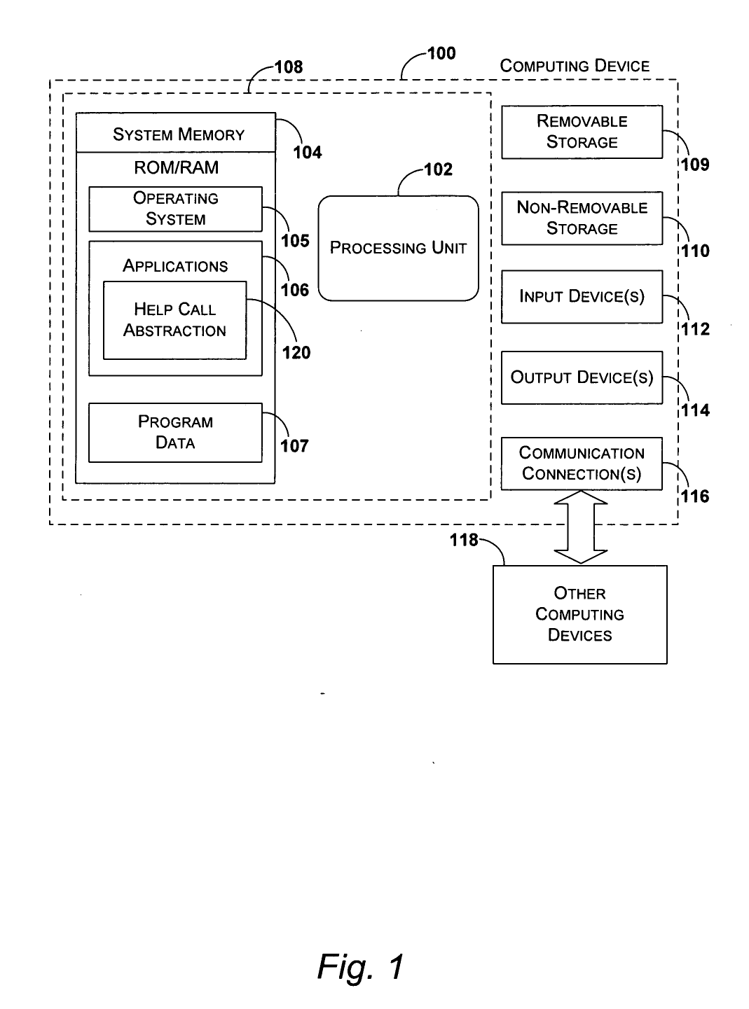

System 200 includes client 202. Client 202 may include computing device 100 as exemplified in FIG. 1. Client 202 is associated with a client program. The client program may include any client program for use on a client 202. For example, the client program may be associated with MICROSOFT WORD, MICROSOFT EXCEL, MICROSOFT POWERPOINT, and/or MICROSOFT WORD ART of MICROSOFT CORPORATION headquartered in Redmond, Wash. The client program may also include help option 203. Help option 203 is typically associated with a client program to provide a help dialog to a user when a user requires help with an aspect of a client program.

System 200 includes a documentation abstraction layer 204. Documentation abstraction layer 204 may reside on client 202, a server, be accessible via a web service, be accessible via a network, and/or reside on a separate computing device. In one example, documentation abstraction layer 208 is a separate program from the client program that has the help option. The documentation abstraction layer 204 may include monitoring service 208, mapping service 210, and help call service 212. In one configuration, monitoring service 208 resides on client 202, and mapping service 210 and help call service 212 reside remotely from client 202.

In one aspect, documentation abstraction layer 204 includes monitoring service 208. Monitoring service 208 monitors or “listens” for a help option selection. When a help option is selected, monitoring service 208 receives a dialog identification associated with dialog of the client program. Even though dialog identification is described herein, monitoring service may receive any type of identifier that indicates a help option selection. Although other file formats may be used, the dialog identification may be associated with an XML document. The mapping may also be affected by user preferences that specify a preference for handling which help call in the mapping is used. The dialog identification is associated with a call signature to facilitate processing on documentation abstraction layer 204. For example, a call signature may be as follows:

CallHelp (Scope, Component, [SubComponent], version, ID, [SearchString])

Parameters of the call signature identify the client program requiring help. Such a call signature facilitates efficient mapping to a help service. Also, versioning information in the call signature provide help for multiple versions of a product running on a computer. For example, when both Microsoft Office XP and Microsoft Office 2003 are running on client 202, the version information may facilitate help distinctions between versions, updates, and service packs. In one aspect, SubComponent and SearchString are optional parameters.

Documentation abstraction layer 204 is also associated with mapping service 210. Mapping service 210 maps the dialog identification to one or more help calls. Mapping service 210 may include an XML file or a hierarchical set of XML files. Mapping service 210 may include an XML fragment that facilitates XPath queries. In this manner, mapping service 210 may quickly associate dialog identifications to help calls. Mapping service 210 may include code separate from the code of documentation abstraction layer 204 so that the documentation abstraction layer 204 and the mapping service 210 may be separately updatable. In one example, mapping service 210 resides on the Internet and monitoring service 208 points to the Internet based mapping service. In this manner, the mapping service may be continuously updated. Also, where monitoring service 208 identifies user options associated with the dialog identification, mapping service 210 may map to help calls in accordance with the user options. For example, a user option may indicate an order for generating help calls (e.g. first call internal help associated with client 202, and second call web-based help). Succinctly stated, mapping service 210 may map dialog IDs to help calls in any manner that facilitates obtaining help and/or obtaining help in accordance with user preferences.

Documentation abstraction layer 204 also includes help call service 212. Help call service 212 sends a help call to help service 206. Help service 206 may include a plurality of help services apart from one another. Help call service 212 may include generating a call associated with a Uniform Resource Locator, HTML, and/or any other manner for generating a help call for sending to a help service.

Help service 206 may be a help service (and/or a plurality of help services) that is located on client 202, on a server, associated with a network, and/or located on an Internet site. Help service 206 includes a help dialog that is associated with a help request of the client program. Help service 206 sends help dialog to client 202 for display on a user interface of client 202.

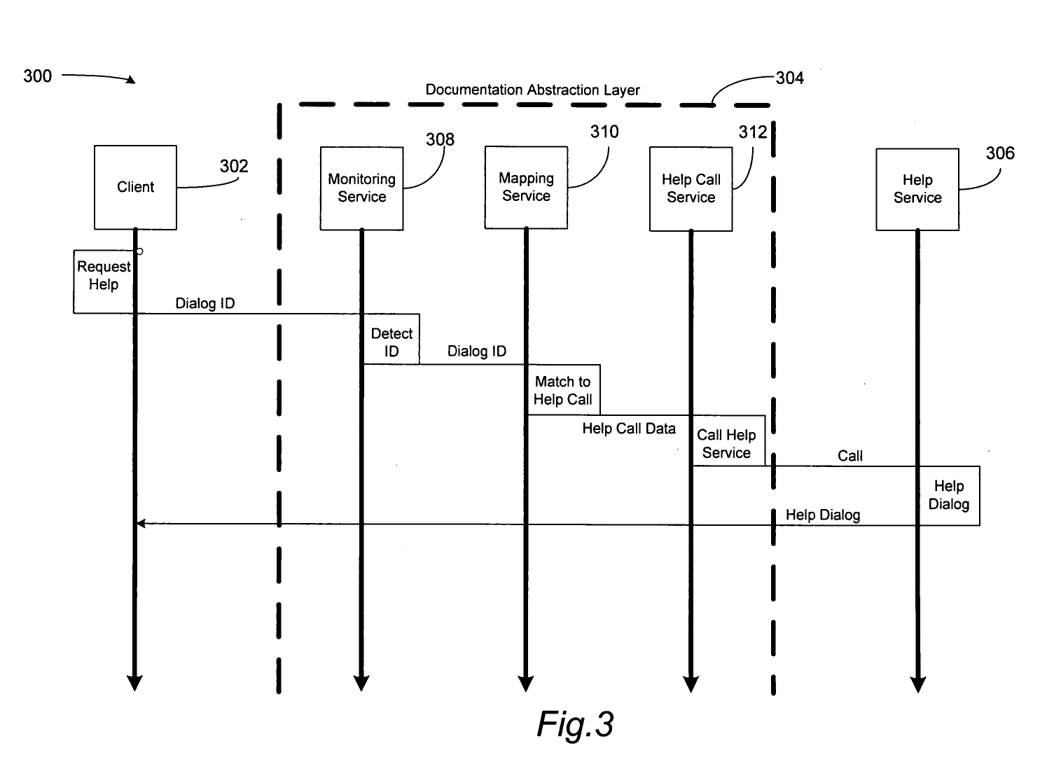

FIG. 3 includes a time dependent flow diagram 300 that represents an exemplary data flow for abstracting help calls using a documentation abstraction layer. Time dependent flow diagram 300 includes client 302, documentation abstraction layer 304, and help service 306. Documentation abstraction layer 304 includes monitoring service 308, mapping service 310, and help call service 312. Elements 302-312 are described above in association with FIG. 2.

As shown in FIG. 3, client 302 generates a help request. For example, a user may be using a client program where help is desired. A user then instigates a help request associated with the client program. When a help request is selected, monitoring service 308 receives a dialog identification associated with the request. In one aspect, the dialog identification is associated with an XML document. In another aspect, the dialog identification is associated with user preferences that indicate a preference for handling a help call. For example, the preference may indicate that help be retrieved from a help service that resides on client 302. As another example, the preference may indicate that help be retrieved from a help service that resides remotely.

In some aspects, the dialog identification is associated with a call signature to facilitate processing on documentation abstraction layer 304. Parameters of the call signature identify the client program requiring help. Also, versioning information in the call signature provides help for multiple versions of a product running on a computer. After the dialog ID is detected, mapping service 310 maps the dialog identification to one or more help calls. Where the monitoring service identifies preferences associated with the dialog ID, mapping service 310 maps to help calls in accordance with the preferences.

Help call data is utilized by help call service 312. The help call data may include an identifier that indicates a help dialog, a URL, and/or any other type of identifier for retrieving a help dialog. Help call service 312 then sends a help call to help service 306. Help service 306 includes a help dialog that is associated with the help required by client 302. The help dialog is then transmitted to client 302.

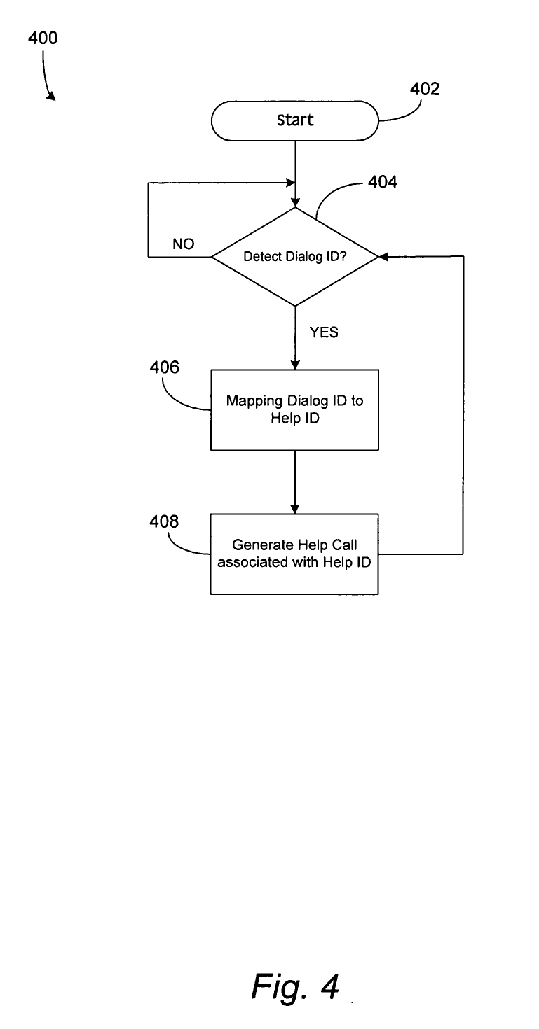

FIG. 4 is an operational flow diagram representing an exemplary embodiment for abstracting help calls. Operational flow 400 begins at start operation 402 and flows to decision operation 404. At decision operation 404 it is decided whether a dialog ID is detected. A dialog ID may be detected by a call to a monitoring service that requests help. Although other file formats may be used, the dialog identification may be associated with an XML document. The mapping may also be affected by user preferences that specify a preference for handling which help call in the mapping is used. The dialog identification is associated with a call signature. If a dialog ID is detected, operational flow 400 continues to operation 406. If a dialog ID is not detected, operational flow 400 loops back to continue monitoring for a dialog ID.

Operation 406 includes mapping the dialog ID to one or more help calls. Operation 406 may include an XML fragment that facilitates XPath queries. Mapping the dialog ID may also include mapping the dialog ID in accordance with a user preference associated with the detected dialog ID. The mapping may map the dialog ID to an identifier that facilitates a call for a help dialog.

Operational flow 400 continues to operation 408 where a help call is generated. The help call is associated with the mapped dialog ID. The help call may include a single help call or multiple help calls to different help services. Operational flow 400 then loops back to decision operation 404 where monitoring for dialog IDs continues.

In accordance with the above, the documentation abstraction layer facilitates updates for a help service without requiring updates to the client program. The documentation abstraction layer provides an efficient, cost effective and time efficient manner for updating a help service and/or services. In that the documentation abstraction layer and the client program are separate programs, the documentation abstraction layer may be updated in order to update help service calls. This updating may occur without requiring the update of the client program. The documentation abstraction layer, therefore, facilitates remapping help topics, adding help topics, removing help topics, changing help topics located on a client, and/or mapping help requests to new online URLs without modification of the client program.

Illustrative Operating Environment

Referring to FIG. 1, an exemplary system for implementing the invention includes a computing device, such as computing device 100. In a basic configuration, computing device 100 may include a stationary computing device or a mobile computing device. Computing device 100 typically includes at least one processing unit 102 and system memory 104. Depending on the exact configuration and type of computing device, system memory 104 may be volatile (such as RAM), non-volatile (such as ROM, flash memory, and the like) or some combination of the two. System memory 104 typically includes operating system 105, one or more applications 106, and may include program data 107. In one embodiment, applications 106 further include application 120 for help call abstraction. This basic configuration is illustrated in FIG. 1 by those components within dashed line 108.

Computing device 100 may also have additional features or functionality. For example, computing device 100 may also include additional data storage devices (removable and/or non-removable) such as, for example, magnetic disks, optical disks, or tape. Such additional storage is illustrated in FIG. 1 by removable storage 109 and non-removable storage 110. Computer storage media may include volatile and non-volatile, removable and non-removable media implemented in any method or technology for storage of information, such as computer readable instructions, data structures, program modules or other data. System memory 104, removable storage 109 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 100. Any such computer storage media may be part of device 100. Computing device 100 may also have input device(s) 112 such as a keyboard, mouse, pen, voice input device, touch input device, etc. Output device(s) 114 such as a display, speakers, printer, etc. may also be included.

Computing device 100 also contains communication connection(s) 116 that allow the device to communicate with other computing devices 118, such as over a network or a wireless network. Communication connection(s) 116 is an example of communication media. Communication media typically embodies computer readable instructions, data structures, program modules or other data in a modulated data signal such as a carrier wave or other transport mechanism and includes any information delivery media. The term “modulated data signal” may include a signal that has one or more of its characteristics set or changed in such a manner as to encode information in the signal. By way of example, and not limitation, communication media may include wired media such as a wired network or direct-wired connection, and wireless media such as acoustic, RF, infrared and other wireless media. The term computer readable media as used herein includes both storage media and communication media.

Although the invention has been described in language that is specific to structural features and/or methodological steps, it is to be understood that the invention defined in the appended claims is not necessarily limited to the specific features or steps described. Rather, the specific features and steps are disclosed as forms of implementing the claimed invention. Since many embodiments of the invention can be made without departing from the spirit and scope of the invention, the invention resides in the claims hereinafter appended.

What is claimed is:

1. A computer-implemented method for abstracting help calls by using a documentation abstraction program that is apart from a program requesting help, the method comprising:
receiving a dialog identification from the program requesting help;
mapping the dialog identification to a help service identifier; and
sending a help dialog request to a help service indicated by the help service identifier.

2. The computer-implemented method of claim 1, wherein the dialog identification is associated with a help request of a client program.

3. The computer-implemented method of claim 1, wherein the dialog identification is associated with an XML document.

4. The computer-implemented method of claim 3, wherein the XML document includes user preferences associated with help service priority.

5. The computer-implemented method of claim 3, wherein the dialog identification is a portion of a call signature.

6. The computer-implemented method of claim 1, wherein the help service identifier is associated with an XML file.

7. The computer-implemented method of claim 1, wherein the help service identifier is associated with a hierarchical set of XML files.

8. The computer-implemented method of claim 1, wherein the help service identifier is associated with an XML fragment that facilitates an XML query.

9. The computer-implemented method of claim 1, wherein mapping the dialog identification to a help service identifier includes mapping the dialog identification to a plurality of help service identifiers.

10. A computer-readable medium having computer-executable instructions for abstracting help calls by using a documentation abstraction layer that is apart from a client program requesting help, the instructions comprising:
detecting a dialog identifier associated with the client program, wherein the dialog identifier indicates a dialog associated with a help request;
associating the dialog identifier with a help service identifier, wherein the help service identifier indicates an address of a help service;
calling the help service in accordance with the help service identifier to request a help dialog associated with the help request.

11. The computer-implemented method of claim 10, wherein the dialog identifier is associated with an XML document.

12. The computer-implemented method of claim 11, wherein the XML document includes user preferences associated with help service priority.

13. The computer-implemented method of claim 11, wherein the dialog identifier is a portion of a call signature.

14. The computer-implemented method of claim 10, wherein the help service identifier is associated with an XML file.

15. The computer-implemented method of claim 10, wherein the help service identifier is associated with a hierarchical set of XML files.

16. The computer-implemented method of claim 10, wherein the help service identifier is associated with an XML fragment that facilitates an XML query.

17. A system for abstracting help requests, the system comprising:
a help request component for generating a dialog identification associated with a request for help, wherein the help request component includes a first set of code, wherein the help request component sends the dialog identification;
an abstraction component for receiving the dialog identification, wherein the abstraction component includes a second set of code that is not part of the first set of code, wherein the dialog identification is mapped to a help call, and wherein the abstraction component sends the help call; and
a help service component for receiving the help call, wherein the help call is associated with a help dialog, and wherein the help dialog is sent to the help request component.

18. The system of claim 17, wherein the abstraction component includes a monitoring component for receiving the dialog identification.

19. The system of claim 17, wherein the abstraction component includes a mapping component for mapping the dialog identification to the help call.

20. The system of claim 17, wherein the abstraction component includes a help call component for sending the help call.
